(19) United States
(12) Patent Application Publication
(10) Pub. No.: US 2012/0299338 A1
(43) Pub. Date: Nov. 29, 2012

(54) VEHICLE JUMP SEAT AND STORAGE SYSTEM

(75) Inventors: Eric J. Hanson, Valparaiso, IN (US); Gay L. Pabst, Davisburg, MI (US)

(73) Assignee: Caterpillar Inc., Peoria, IL (US)

(21) Appl. No.: 13/117,253

(22) Filed: May 27, 2011

(51) Int. Cl. B60N 2/02; B60N 2/44

(52) U.S. Cl. 297/183.1; 297/188.08

(57) ABSTRACT

A vehicle seat comprising a seat back and a seat bottom configured to rotate relative to the seat back. The seat bottom includes a center section, side sections on either side of the center section, and a handle. The handle extends from one side section to the other side section and across the center section.

### TECHNICAL FIELD

The present disclosure relates to a jump seat in a vehicle. More particularly the present disclosure relates to a jump seat and storage system.

### BACKGROUND

Many vehicles include jump seats that can be rotated upward when not in use. Vehicles also have seats with storage areas underneath. PCT Patent Publication WO 2005/025926 discloses one such storage device under a seat along with a recess in the front of the seat.

### SUMMARY

In one aspect, a vehicle seat is provided comprising a seat back and a seat bottom configured to rotate relative to the seat back. The seat bottom includes a center section, a side section on one side of the center section, another side section on an opposite side of the center section, and a handle. The handle extends from one side section to the other side section and across the center section.

In another aspect, a vehicle seat is provided comprising a seat back and a seat bottom configured to rotate relative to the seat back. The seat bottom includes a handle in the seat bottom that is accessible from a top, underneath, and front surface of the seat bottom

In yet another aspect, a vehicle interior is provided comprising a jump seat and a base storage unit. The base storage unit is located under the jump seat and spaced away from the jump seat to create a spacing between an underneath of the jump seat and a top of the base storage unit.

Other features and aspects of this disclosure will be apparent from the following description and the accompanying drawings.

### BRIEF DESCRIPTION OF THE DRAWINGS

FIG. 1 is a perspective view from the front left of a vehicle showing an interior with a modular storage system.

FIG. 2 is a perspective view from the front left of a vehicle showing an interior with a jump seat and storage system.

FIG. 3 is a perspective view of the modular storage system from FIG. 1 with an upper storage unit moving down onto a base storage unit.

FIG. 4 is a perspective view of the modular storage system from FIG. 1 with an upper storage unit coupled to a base storage unit top to form an attachment wall.

FIG. 5 is a perspective view of the modular storage system from FIG. 1 but from the front right of the vehicle to show another side of the storage system.

FIG. 6 is a perspective view of the vehicle interior from FIG. 1 with an operator using the modular storage system.

FIG. 7 is a front view of a portion of an accessory receiving system.

FIG. 8 is a side view of an accessory to be coupled to an accessory receiving system.

FIG. 9 is a cross-section view of the attachment wall from FIG. 7 to receive the accessory from FIG. 8.

FIG. 10 is a cross-section view showing a clip connecting the upper storage unit to the base storage unit of the storage system from FIG. 4.

FIG. 11 is a perspective view of a bungee.

FIG. 12 is a perspective view of the bungee from FIG. 11 with an end fitted over a lid of the upper storage system from FIG. 4.

FIG. 13 is a cross-section view of the end fitted over the lid from FIG. 12.

FIG. 14 is a perspective view of a spider connecting a plurality of elastic retaining members from FIG. 4.

FIG. 15 is a perspective view of the jump seat and storage system from FIG. 2.

FIG. 16 is a perspective view of the jump seat and storage system from FIG. 2 with an operator using the jump seat.

FIG. 17 is a perspective view of the jump seat and storage system from FIG. 2 with the jump seat rotated up.

FIG. 18 is a front view of the jump seat and storage system from FIG. 2.

### DETAILED DESCRIPTION

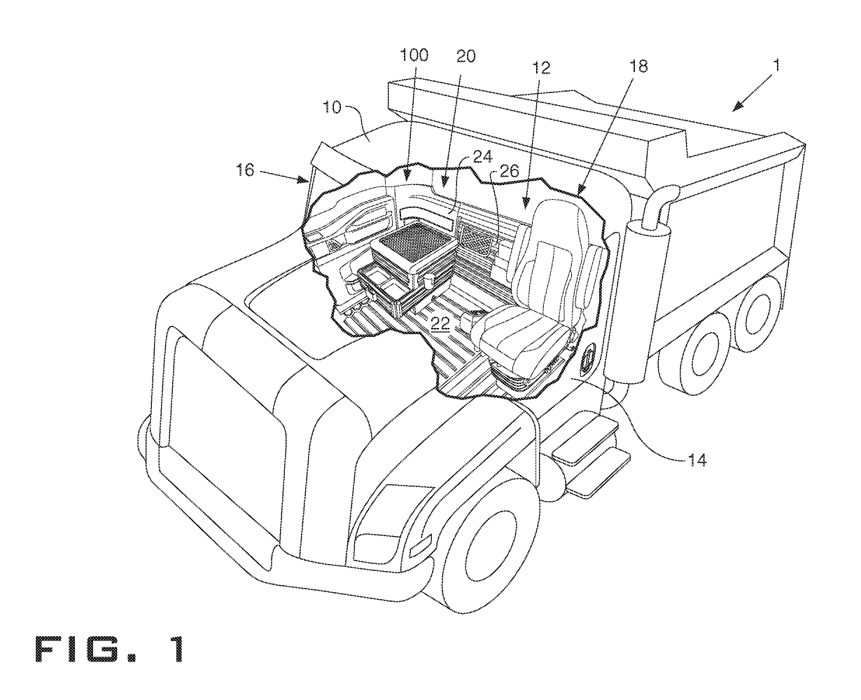

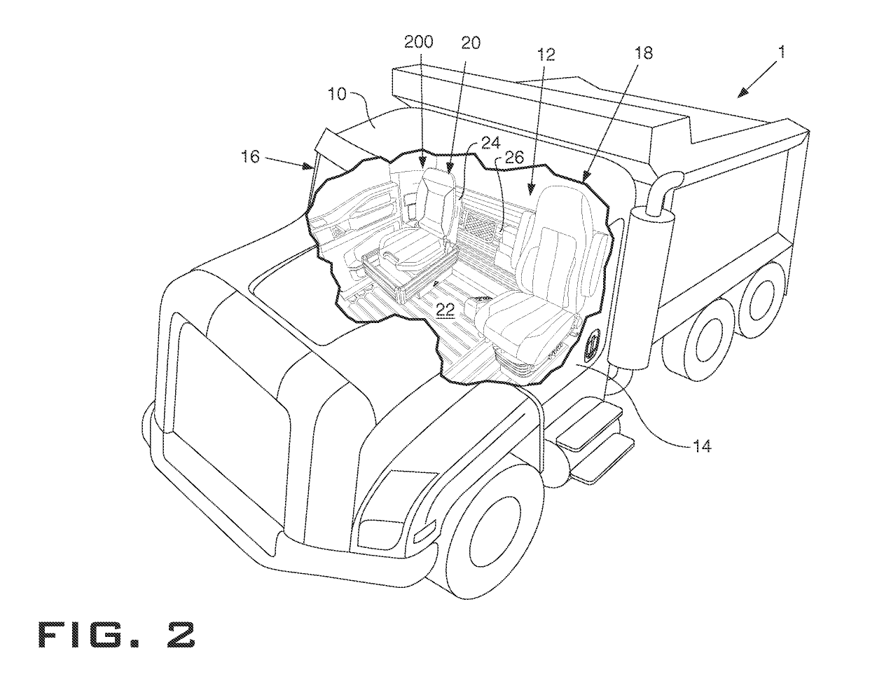

FIGS. 1 and 2 illustrate a vehicle 1 including a cab 10. The vehicle 1 is shown as a vocational or work truck and specifically a dump truck. However, the vehicle 1 may be any type of machine with a cab to provide for an operator. For example, the vehicle 1 may also be a passenger car, pick-up truck, garbage truck, delivery truck, cement mixer, tow truck, off-highway truck, articulated truck, long haul on-highway truck, mining equipment, construction equipment, earth moving equipment, aerospace application, marine application, locomotive, or anything of the like.

The cab 10 as shown includes an interior 12, operator door 14, and a side door 16. The operator door 14 is adjacent to an operator position 18 where the operator sits to operate the vehicle 1. The side door 16 is adjacent to a side position 20 across the cab 10, opposite from the operator position 18. Some vehicles 1 may not include one or both doors 14 and 16 and may include more doors.

The interior 12 includes a floor 22, back wall 24, accessory wall 26, and a mount box 28. The mount box 28 (seen in FIGS. 5 and 18) may house the interior HVAC fan and electronics or may be used for other systems of the vehicle 1. However, the mount box 28 could be any box or structure that could be located and used for mounting as described herein. The box 28 is mounted to the floor 22 in the side position 20 adjacent to the side door 16 and against the back wall 24.

FIG. 1 shows the interior 12 may include a modular storage system 100. FIG. 2 shows the interior 12 may include a jump seat and storage system 200 that may be added to the modular storage system 100 or substituted or interchanged for all or a portion of the modular storage system 100.

The modular storage system 100 includes a base unit 110, upper unit 120, attachment system 140, accessory receiving system 160, and article retention system 180. The base unit 110 and upper unit 120 are box structures for holding items inside.

The base unit 110 is mounted onto the mount box 28. The base unit 110 may also be mounted to the back wall 24 or other structures. Because the base unit 110 is wider than the mount box 28 or the base unit 110 otherwise overhangs the mount box 28, an open space 30 is created underneath the base unit 110. The open space 30 may be bounded by the floor 22, back wall 24, base unit 110, and mount box 28 but open from the front and operator position 18.

In one embodiment, the open space 30 represents approximately 28% (+ or −10%) of the area under the base unit 110. In yet another embodiment, the open space 30 may represent greater than 15% of the area under the base unit 110. In yet another embodiment, the open space 30 may represent between 15% and 40% of the area under the base unit 110. In other embodiments the open space 30 may be larger or smaller. The open space 30 is large enough to be useful but small enough for the base unit 110 to be sufficiently supported.

The base unit 110 includes a bottom 112, sides 114, top 116, and compartments 118. The bottom 112 and sides 114 form a box structure. The compartments 118 are located inside this box structure. The compartments 118 hold any of a variety of objects. Any number and type of compartments 118 may be included. The compartments 118 may also be re-configurable or removed. The compartments 118 may also slide or move with the base unit 110.

The upper unit 120 includes a bottom 122, sides 124, top 128, and a lid 130. The bottom 122 and sides 124 form a box structure. Like the base unit 110, the upper unit 120 may also include compartments inside the box structure.

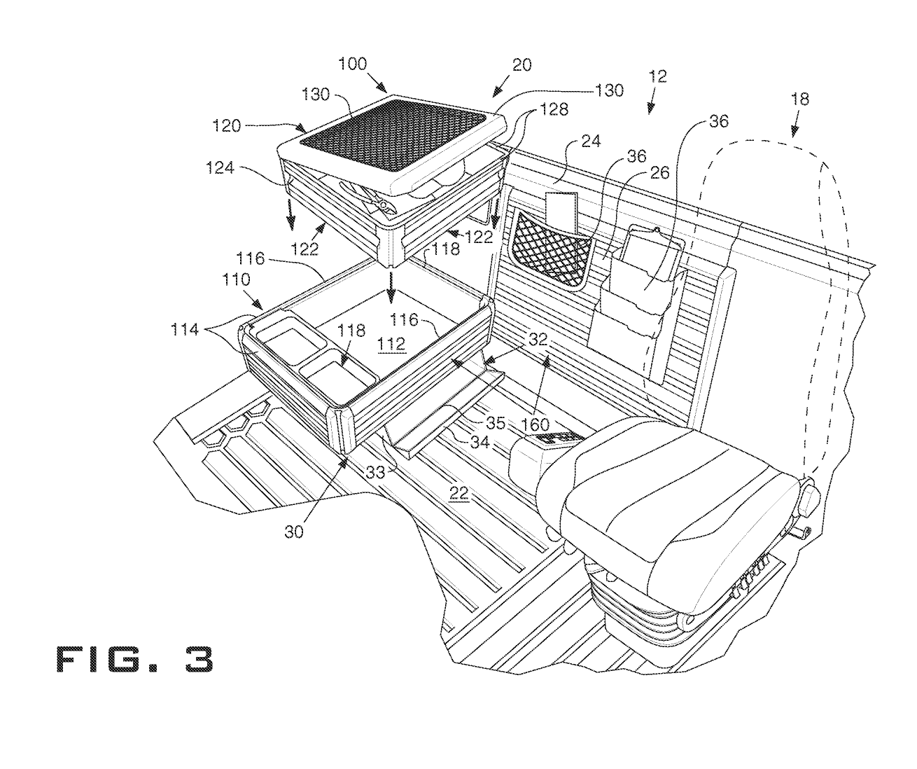

FIG. 3 shows that the upper unit 120 may be located on top of or coupled to the base unit 110. In one embodiment, the bottom 122 of the upper unit 120 is coupled to the top 116 of the base unit 110.

The upper unit 120 is configured to be removably coupled to the base unit 110. As used herein, the term removably refers to being able to remove something without the use of destructive means like cutting, melting, tearing, breaking, performing involved disassembly, or requiring the use of tools.

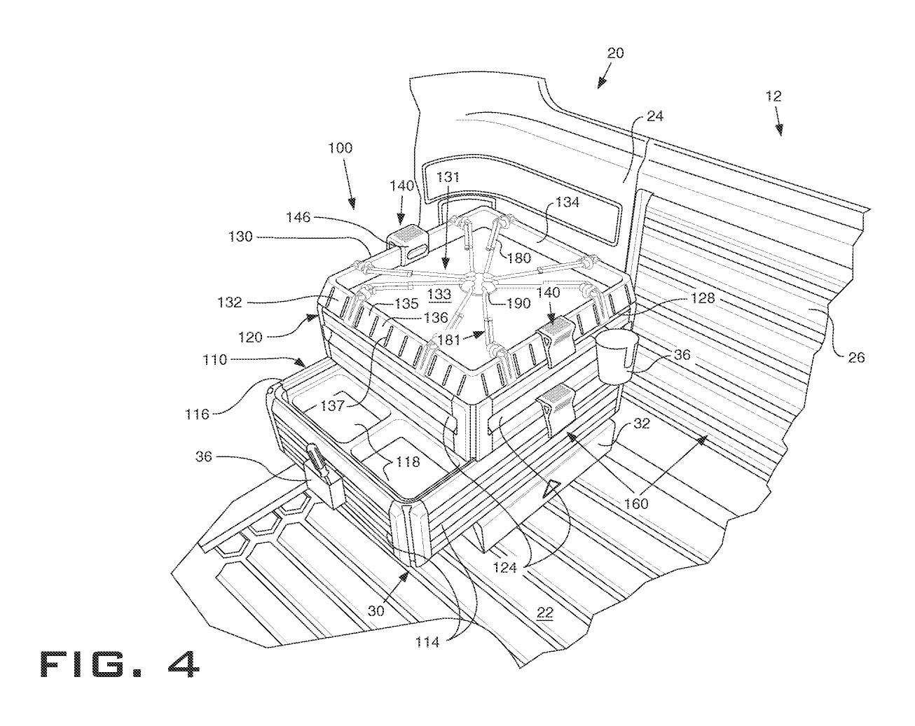

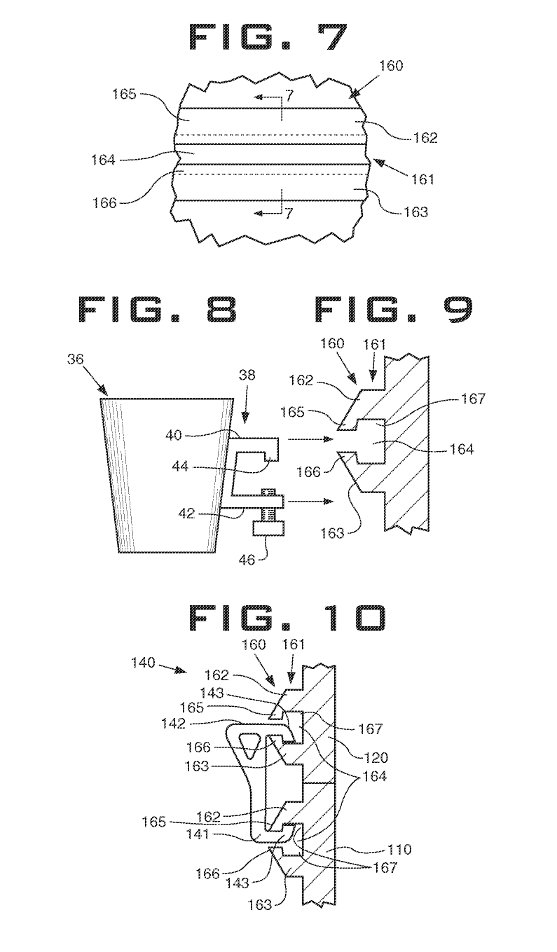

As seen in FIGS. 4, 5, 6, and 10, the upper unit 120 is coupled to the base unit 110 using the attachment system 140. The attachment system 140 may include clips 141 that secure the base unit 110 to the upper unit 120. Shown best in FIG. 10, the clips 141 may include a release surface 142 and tabs 143. The release surface 142 may be pressed to remove the clip 141. The tabs 143 interact with the base and upper units 110 and 120, coupling them together. As seen in FIG. 7, the clips 141 may work with the accessory receiving system 160 to accomplish their function.

In one embodiment and as seen in FIG. 5, the clip 141 may also include a hinge 144 to allow the lid 130 to be rotated upward to access the contents of the upper unit 120. The clip 141 may also include an overhang 146 used to firmly hold the lid 130 when the hinge 144 is used. As seen in FIG. 3, conventional hinges on the lid 130 may be used if the clips 141 are not used to hold the lid 130.

The accessory wall 26 and sides 114 of the base unit 110 and sides 124 of the upper unit 120 may include the accessory receiving system 160. This accessory receiving system 160 allows for an accessory 36 to be attached. The accessory receiving system 160 may allow for these accessories 36 to removably coupled and removed to allow the accessories 36 to be selected, moved, and arranged as desired by the operator. Examples of accessories 36 may include cup holders, tool holders, nets or bags to hold miscellaneous items, slot holders to hold files or clip boards, map holders, clips to hold papers, phone holders, hooks, and the like.

In one embodiment, the accessory receiving system 160 may include tracks 161, an example of which is shown in FIGS. 7, 8, and 10. Such tracks 161 allow the accessories 36 to be located in a plurality of locations along the length of the tracks 161 and at predetermined heights where the tracks 161 run. The tracks 161 may be extruded or machined and may have a constant cross-section.

Seen best in FIG. 9, the tracks 161 may include upper tangs 162 and lower tangs 163 that extend to form slots 164 between the upper and lower tangs 162 and 163. The upper and lower tangs 162 and 163 and slots 164 run the length of the accessory receiving system 160. The tangs 162 may also have upper overhangs 165 projecting downward from the upper tang 162 and lower overhangs 166 projecting upward from the lower tang 163 to form recessed slots 167. Many varieties of alternative track systems are available in the art for use.

As seen in FIG. 8, the accessories 36 may include an engagement system 38 to couple the accessory 36 to the accessory receiving system 160. The engagement system 38 may include an upper protrusion 40 and a lower protrusion 42 that interact with slots 164 and upper and lower tangs 162 and 163. The engagement system 38 may include an overhang 44 extending from the upper protrusion 40 or lower protrusion 42 to interact in one of the recessed slots 167 of the tracks 161. The engagement system 38 may also include an active retention device 46 to secure the accessory 36 to the accessory receiving system 160. This active retention device 46 may be a screw, turning tab, spring loaded tab, or other such device to positively apply force on a feature of the accessory receiving system 160. As seen in FIG. 10, the clip 141 of the attachment system 140 may interact with a track 161 on the base unit 110 and a track on the upper unit to secure the base unit 110 to the upper unit 120.

The lid 130 fits over the top 128 of the upper unit 120 to close and open and to provide access to the inside of the box structure. The lid 130 may latch onto the top 128, may be lockable, and may rotate. As shown in FIG. 3, the lid may also include netting over the top that allows the contents to be seen.

FIGS. 4, 5, 6, and 13 show that in another embodiment the lid 130 may include a recessed area 131 and a lip 132. The recessed area 131 is formed by a sunken floor 133 and walls 134. In one embodiment the lip 132 includes a ramp 135. On the ramp 135 are slots 136 formed by projections 137. The ramp 135 may extend from a flat 138 and terminate at an end 139 at the bottom of the ramp 135.

The article retention system 180 goes over the top of the lid 130 to secure objects put in the recessed area 131. The article retention system 180 includes a bungee 181. The bungee 181 includes an elastic member 182 and end 183. The elastic member 182 may be any elastic cord, tube, strap, or the like that can stretch across the recessed area 131. The elastic member 182 may be polyurethane, rubber, or another elastic member or may consist of a collection of such elastic members like a bungee cord.

The end 183 is coupled to either side of the elongated elastic member 182. The end 183 includes a coupling portion 184, an elongated portion 185, and hook portion 186. The coupling portion 184 includes openings 187 that receive and couple the elastic member 182 to the end 183. The elastic member 182 may pass through the openings 187 and wrap around to couple the elastic member 182 to the end 183 by interference. In another embodiment the elastic member 182 may be crimped inside an opening 187 or may be otherwise adhered to the end 183.

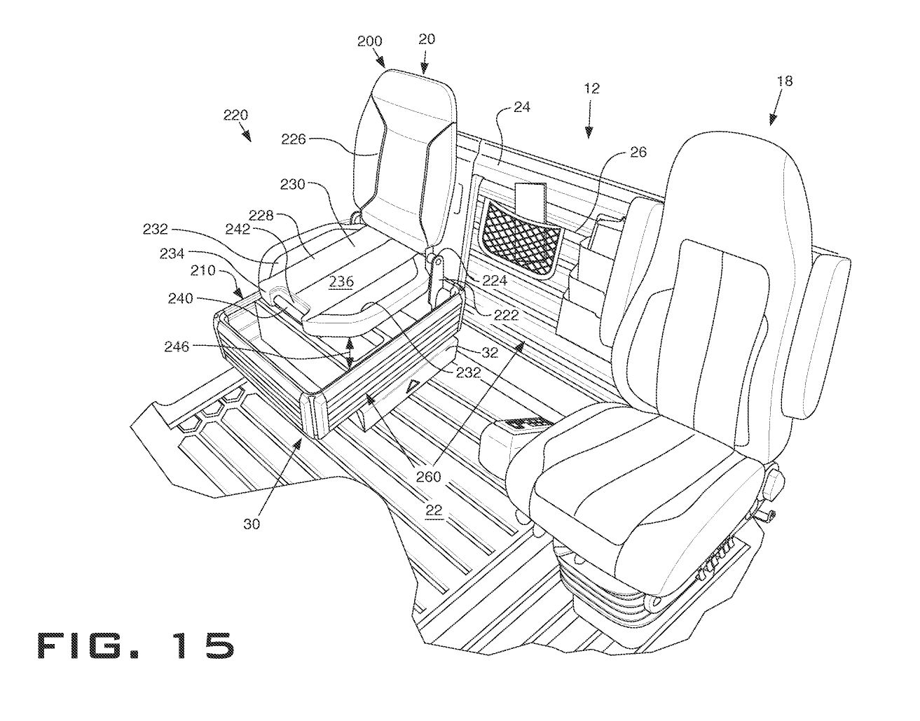

Seen best in FIG. 12, the elongated portion 185 may be of a width and length to match the slots 136 of the lip 132. In some embodiments, the elongated portion 185 may not be as wide the slots 136 between projections 137. As seen best in FIG. 13, the elongated portion 185 may also extend at an angle 80 from the coupling portion 184 that matches the angle 80 from the flat 138 to the ramp 135 of the lip 132. As shown in FIGS. 12 and 13, the hook portion 186 curls around or fits over the end 139 of the lip 132. With both ends 183 installed, the bungee 181 is thereby secured over the top of the lid 130.

The end 183 may also include a web 188 or other similar feature. The web 188 may extend up from the and coupling portion 184 and elongated portion 185. The web 188 may provide a location for at least some of the openings 187 in the coupling portion 184. The web 188 may also provide strength to the elongated portion 185, allowing it to be thin.

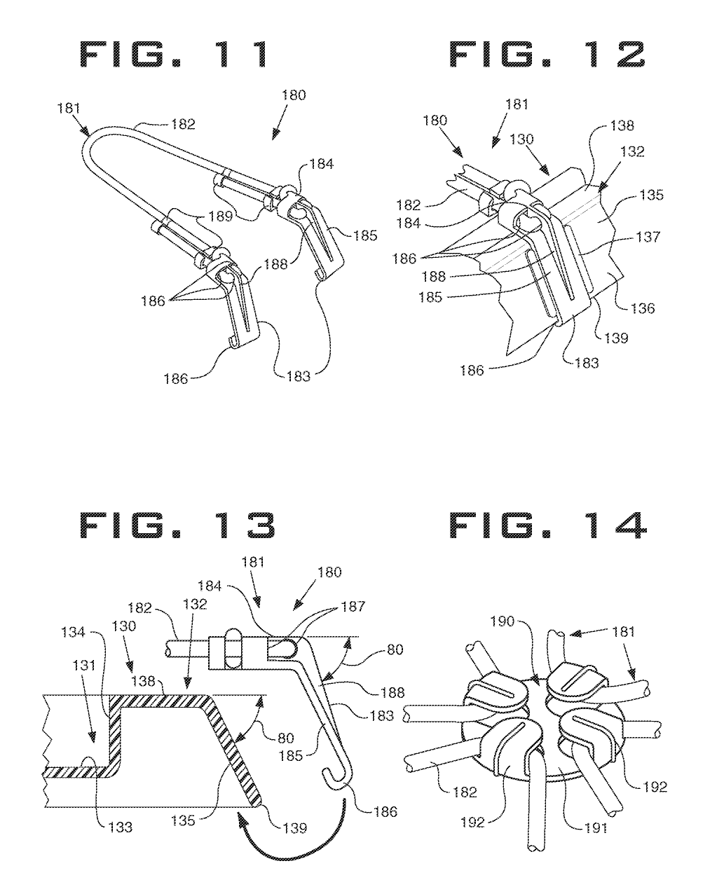

Seen best in FIG. 11, the effective length of the bungee 181 may be adjustable. In one embodiment, the elastic member 182 may be pulled through or be backed out of the coupling portion 184 to adjust the effective length. Clips 189 may then be used to secure free ends of the elastic member 182.

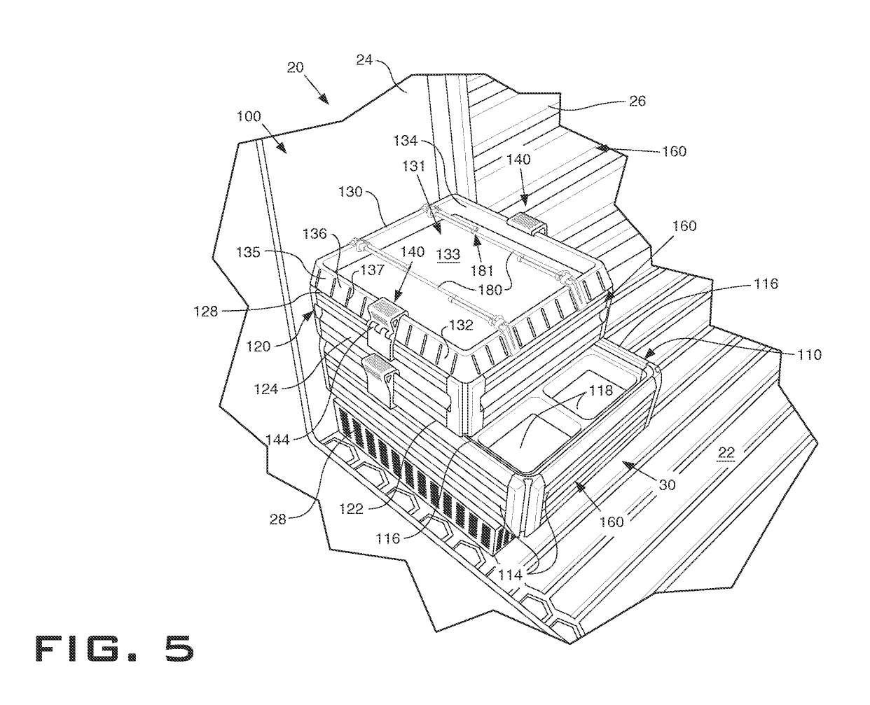

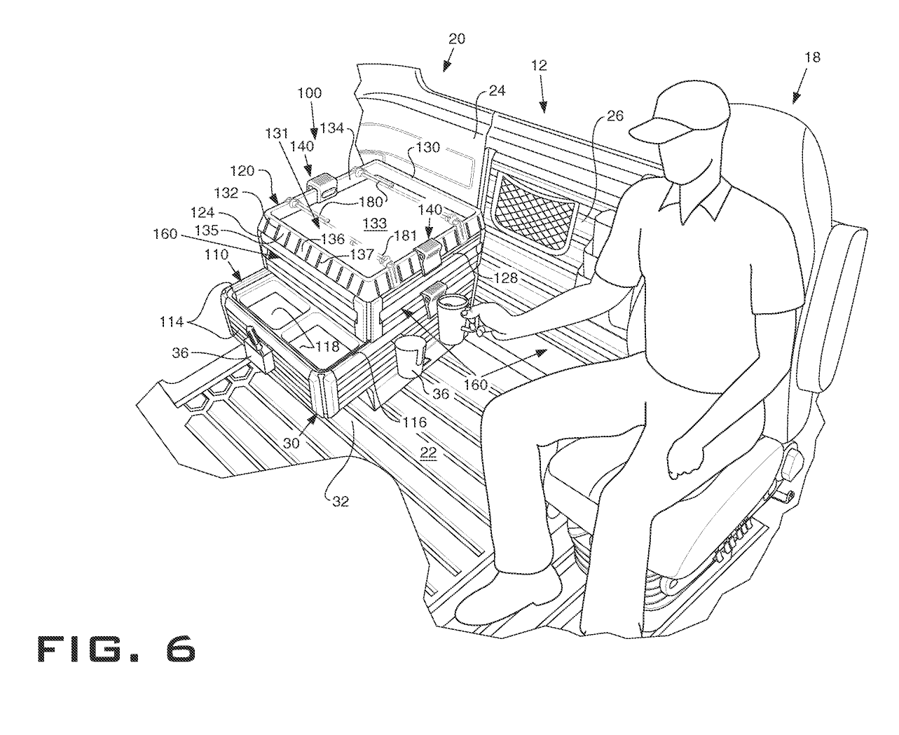

FIGS. 4, 5, and 6 show different ways that a plurality of bungees 181 can be used in the article retention systems 180. FIG. 5 shows two bungees 181 going across the lid 130 in one direction and FIG. 6 shows the two bungees 181 going across the lid in an opposite direction.

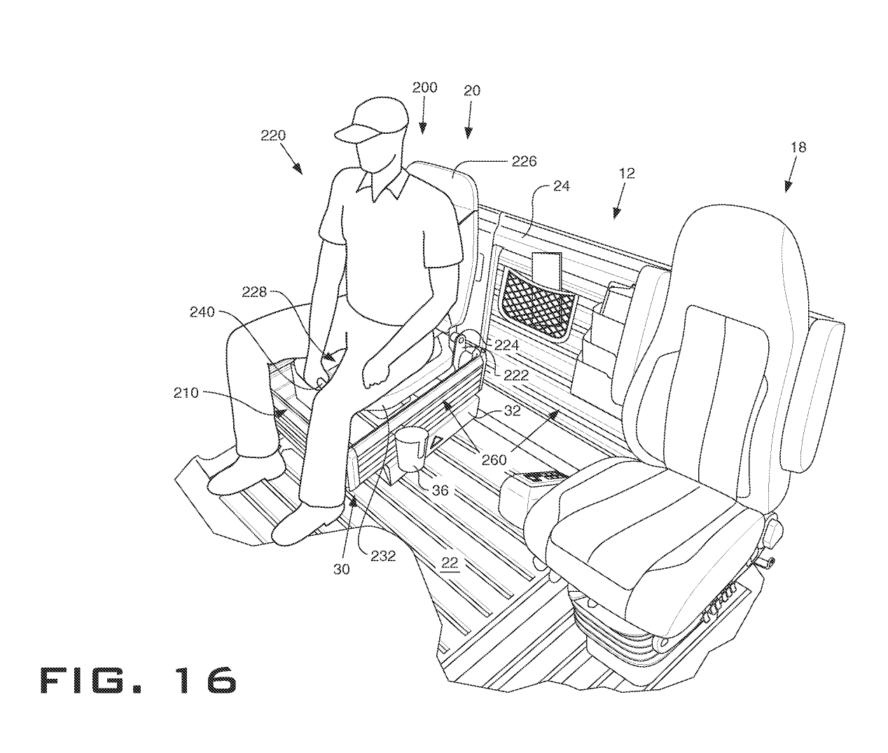

FIG. 4 shows the article retention systems 180 may also employ a spider 190. The spider 190 is shown in more detail in FIG. 14. The spider 190 is a device to redirect the elastic member 182 of the bungee 181 so that it does not go straight across the lid 130. The spider 190 may also interconnect multiple bungees 181. FIG. 4 shows the spider 190 redirecting four bungees 181 so that each returns to the same side of the lid 130 the bungee 181 started from.

Seen best in FIG. 14, the spider 190 includes a disk 191 and tabs 192. The tabs 192 extend upward from an outer periphery of the disk 191. The tabs 192 then curve over towards the center of the disk 191. The elastic member 182 fits under the tabs 192 and is redirected. The common disk 191 also serves to link the bungees 181 it shares. In other embodiments the spider 190 could be replaced by a loop, which may be elastic, or any other device that redirects and/or interconnects multiple bungees 181.

As seen in FIGS. 15, 16, 17, and 18, the jump seat and storage system 200 includes a base unit 210, jump seat 220, and accessory receiving system 260. The base unit 210 and accessory receiving system 260 of the jump seat and storage system 200 may be the same as the base unit 110 and accessory receiving system 160 of the modular base storage unit 110 described above and therefore will not be described again here.

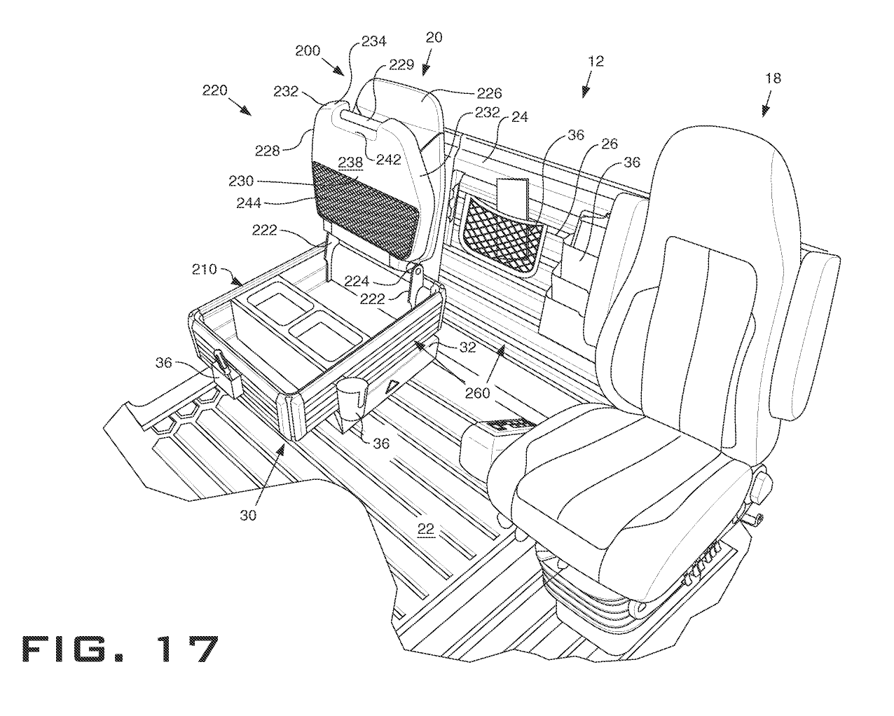

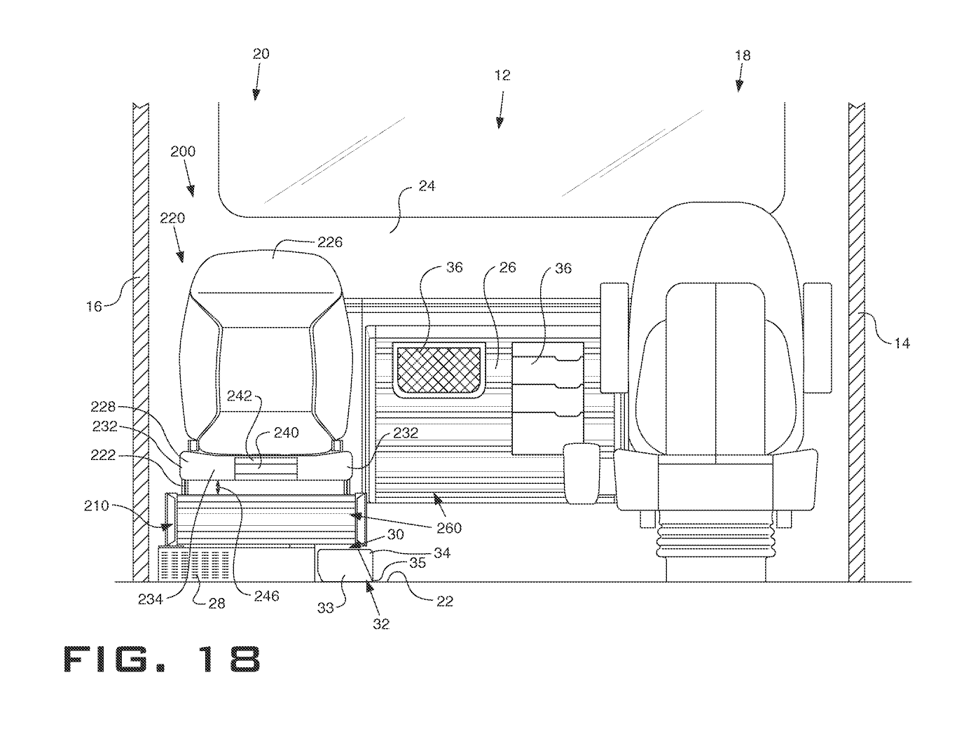

The jump seat 220 includes a mount 222, pivot 224, seat back 226, and seat bottom 228. Seen best in FIG. 17, the seat mount 222 is used to mount the jump seat 220 to the interior 12 of the vehicle 1. The mount 222 may be secured to the base unit 210, floor 22, back wall 24, or another component of the vehicle 1 or a combination of components. As shown, the mount 222 may extend up through the inside of the base unit 210.

The pivot 224 allows the seat bottom 228 to rotate relative to the seat back 226. In one embodiment, the seat bottom 228 rotates down relative to the seat back 226 to an in-use position as seen in FIG. 15. The seat bottom 228 also rotates up relative to the seat back 226 to an out-of-use position as seen in FIG. 17. The seat bottom 228 may be put into the in-use position to sit on and the out-of-use position to gain access inside the base unit 210. A latch or lock may also be included to keep the seat bottom 228 in the in-use or out-of-use positions.

The pivot 224 may include a rod or other hinge known in the art to pass through a rear portion of the seat bottom 228 to allow it to rotate. The rod may also pass through a bottom of the seat back 226 and mount 222 thereby securing the seat bottom 228, seat back 226, and mount 222 together. In another embodiment the seat back 228 may be mounted separately, possibly on the back wall 24.

The seat bottom 228 includes a center section 230, side sections 232, front 234, top 236, underneath 238, handle 240, and front center pocket 242. The side sections 232 extend outward on either side of the center section 230 and may slant backwards from the front away from the center section 230. The top 236 is the surface of the seat bottom 228 a user sits on. The underneath 238 is the surface of the seat bottom 228 facing the base unit 210. As shown in FIG. 17, the underneath 238 may include a pocket or netting 244 that can be used to hold miscellaneous objects that can be accessed when the seat bottom 228 is in the out-of-use position.

The front center pocket 242 is a recess cut into the center section 230 at the front 234 of the seat bottom 228. The front center pocket 242 may be open from the top, underneath and front of the seat bottom 228.

The handle 240 is located to be held by the user while sitting in the jump seat 220. In one embodiment, the handle 240 may also be located so the user can hold it without raising her arms. The handle 240 may also be located to be accessible to rotate the seat bottom 228 relative to the seat back 226. The handle 240 may also be located to have a low profile and not extend beyond the outer perimeter of the seat bottom 228.

The handle 240 may be a straight bar with a circular cross-section. In other embodiments the handle 240 may bend, curve, or have another shape. The handle 240 may also have a cross-section of a different shape. The handle 240 is long enough to be grabbed by a user and therefore the portion of the handle 240 exposed in the front center pocket 242 is at least as long as the width of most hands. In one embodiment, the portion of the handle 240 exposed in the front center pocket 242 is at least 4 inches long. In another embodiment, the portion of the handle 240 exposed in the front center pocket 242 is between 4 and 7 inches long.

The handle 240 is also close enough to the front 234 of the seat bottom 228 in the front center pocket 242 to be used by a user sitting in the jump seat 220 as seen in FIG. 6. In one embodiment, the handle 240 is located within 4 inches from the front 234 of the seat bottom 228. In another embodiment, the handle 240 is located between 1 and 3.5 inches from the front 234 of the seat bottom 228.

In one embodiment, the handle 240 extends from the side sections 232 and across the center section 230 through the front center pocket 242. The handle 240 may be between the top 236 and underneath 238 surfaces and not extend beyond the front 234. The handle 240 may be accessible from the top, underneath, and front of the seat bottom 228 but not accessible from the sides.

Seen best in FIG. 18, the seat mount 222 and pivot 224 may create a spacing 246 between the underneath 238 of the seat bottom 228. The spacing 246 may be created by cantilevering the seat bottom 228 from the pivot 224 and suspending the seat bottom 228 over the base unit 210.

### INDUSTRIAL APPLICABILITY

The modular storage system 100 and jump seat and storage system 200 described above provides many features for use in a vehicle 1. Because the modular storage system 100 and jump seat and storage system 200 share the same basic base unit 110 and 210 and accessory receiving system 160 and 260, a level of commonality is achieved between the interchangeable modular storage system 100 and jump seat and storage system 200. This commonality may help reduce costs while improving functionality and optimization. The commonality may also help create a common look for different interior configurations that may help with consumer brand identification.

The open space 30 provides a location for the placement of a variety of objects that may need to be stored in the interior 12. One such object might be a safety box 32 used to house the required reflective safety triangles and other devices that operators of some vehicles 1 are required to carry. This safety box 32 or other objects may fit entirely within the open space 30 or may extend outside of it. In one embodiment, the open space 30 may define a dedicated location for the safety box 32. This dedicated location may have brackets, straps, or other retaining devices specifically sized to hold a safety box 32 of a certain size. The safety box 32 may also be specifically designed to fit in the open space 30.

Seen best in FIG. 18, the safety box 32 may include a base 33 where the reflectors and other contents are stored. The safety box 32 may also include a lid 34 closing the base 33. The lid 34 may be pivotally connected to the base 33 using a hinge 35. In one embodiment, the safety box 32 may be configured to fit in the open space 30 with the lid 34 opening to the side so the operator can access the contents without removing the safety box 32, as seen in FIG. 3. The hinge 35 may be located on the bottom so the lid 34 opens by rotating downward.

The open space 30 may also be used to allow long items, such as a shovel, sledge hammer, flag, umbrella, or the like, to be stored in the interior 12. Providing locations for an elongated object to lay flat in an interior 12 can be a challenge, but the mounting design of the base unit 110 and resulting open space 30 have created such a space between the mount box 28 and operator position 18 on the floor 22. The open space 30 may also be used to store items that are too heavy for the storage units 110 and 120.

The accessory receiving system 160 provides for the customizable arrangement of accessories 36 as needed by a user depending on the situation. Employing the same accessory receiving system 160 on the accessory wall 26 and sides 114 of the base unit 110 and sides 124 of the upper unit 120 allows additional flexibility by allowing the same accessories 36 to be used. Building the size of the accessory receiving system 160 when the upper unit 120 is installed also adds functionality by increasing the vertical storage area possible with the accessory receiving system 160.

Because the handle 240 is open from the top and front of the seat bottom 228, the handle 240 can be used for stability by the user during travel without the need to raise her arm to reach a handle above the side door 16. The location also allows the handle 240 to be used by the person sitting in the jump seat 220 as seen in FIG. 16. Because she does not need to raise her arm, this position may be more comfortable for the user. Also because she does not need to raise her arm, visibility for the driver may be improved since the arm is no longer blocking the side window.

Because of the accessibility and location of the handle 240, it can also be used by a user during ingress and egress into the vehicle 1. Meanwhile, because the handle 240 is in the recessed front center pocket 242 and does not extend beyond the perimeter of seat bottom 228, the handle 240 may not be snagged or otherwise in the way of an operator.

Because the handle 240 is open from the top of the seat bottom 228, the handle 240 is accessible to be used to rotate the seat bottom 228 upward to the out-of use position. Because the handle 240 is open from the underneath of the seat bottom 228, the handle 240 is also accessible to be used to rotate the seat bottom 228 downward to the in-use position.

The cantilevered seat bottom 228 with the resulting spacing 246 may reduce the stress on the base unit 210, which allows the base unit 210 to be mounted in such a way as to create the open space 30 underneath. The cantilevered seat bottom 228 with the resulting spacing 246 also allows the base unit 210 to be at least partially accessed while the seat bottom 228 is in the in-use position.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A vehicle seat comprising:
a seat back; and
a seat bottom configured to rotate relative to the seat back, the seat bottom including:
a center section;
a side section on one side of the center section and another side section on an opposite side of the center section; and
a handle extending from one side section to the other side section and across the center section.

2. The vehicle seat of claim 1, wherein the handle is located at a front of the seat bottom.

3. The vehicle seat of claim 1, wherein the handle extends through a front center pocket cut into a front of the center section.

4. The vehicle seat of claim 1, wherein the handle does not extend outside an outer perimeter of the seat bottom.

5. The vehicle seat of claim 1, wherein the handle is accessible from a top, underneath, and front surface of the seat bottom.

6. The vehicle seat of claim 1 together with the seat back forming a jump seat located in a side position of a vehicle interior opposite an operator position of the vehicle interior.

7. The vehicle seat of claim 1 configured to be cantilevered over a base storage unit to create a spacing between the underneath of the seat bottom and a top of the base storage unit.

8. A vehicle seat comprising:
a seat back; and
a seat bottom configured to rotate relative to the seat back, the seat bottom including a handle in the seat bottom that is accessible from a top, underneath, and front surface of the seat bottom

9. The vehicle seat of claim 8, wherein the handle is located at a front of the seat bottom and the handle extends across a center section of the seat bottom.

10. The vehicle seat of claim 8, wherein the handle extends through a front center pocket cut into a front of a center section of the seat bottom.

11. The vehicle seat of claim 8, wherein the handle does not extend outside an outer perimeter of the seat bottom.

12. The vehicle seat of claim 8 together with the seat back forming a jump seat located in a side position of a vehicle interior opposite an operator position of the vehicle interior.

13. The vehicle seat of claim 8 configured to be cantilevered over a base storage unit to create a spacing between the underneath of the seat bottom and a top of the base storage unit.

14. A vehicle interior comprising:
a jump seat; and
a base storage unit located under the jump seat and spaced away from the jump seat to create a spacing between an underneath of the jump seat and a top of the base storage unit.

15. The vehicle interior of claim 14, wherein the base storage unit is mounted on a box located on a floor of the vehicle and adjacent a door of the vehicle, and the base storage unit overhangs the box thereby creating a open space between the base unit and the floor that is open from a front and a side opposite the door of the vehicle the box is located adjacent to.

16. The vehicle interior of claim 14, wherein the jump seat includes a seat bottom including:
a center section;
a side section on one side of the center section and another side section on an opposite side of the center section; and
a handle extending from one side section to the other side section and across the center section.

17. The vehicle interior of claim 14, wherein the jump seat includes a seat bottom including a handle in the seat bottom and the handle is accessible from top, underneath, and front surfaces of the seat bottom.

18. The vehicle seat bottom of claim 17, wherein the handle is located at a front and extends across a center section of the seat bottom.

19. The vehicle interior of claim 14, wherein the jump seat is cantilevered over the base storage unit.

20. The vehicle interior of claim 19, wherein the jump seat is cantilevered from a pivot used to rotate the seat bottom relative to a seat back.
